(19) United States
(12) Patent Application Publication
(10) Pub. No.: US 2007/0034672 A1
(43) Pub. Date: Feb. 15, 2007

(54) Method of and installation for rolling in-process stock

(76) Inventor: Wolfgang Denker, Duesseldorf (DE)

Correspondence Address: ABELMAN, FRAYNE & SCHWAB, 666 THIRD AVENUE, 10TH FLOOR, NEW YORK, NY, 10017, US

(21) Appl. No.: 10/576,848

(22) PCT Filed: Nov. 8, 2004
(86) PCT No.: PCT/EP04/12601

§ 371 Date: Apr. 20, 2006

(30) Foreign Application Priority Data
Dec. 10, 2003 (DE) 103 57 622.3

(51) Int. Cl. A47J 36/02

(52) U.S. Cl. 228/101

(57) ABSTRACT

The invention relates to a method of rolling a strip-shaped in-process stock, in particular a metal strip, with which, a metal strip (3) is unwound from a coil (2, 7) held on an unwinding reel (1, 6), is fed into a reversing rolling mill (8), is rolled, and is wound-up onto a winding-up reel (9) to form a coil (10), wherein the metal strip (3) is reversibly conveyed from the unwinding reel (1, 6) to the winding-up reel (9) until a set thickness is reached and, with each passing of the reversing rolling mill (8), is subjected to a reduction of thickness, and wherein an end of the metal strip (3) of a first coil is welded to a beginning of the metal strip (3) of the second coil, and the metal strip (3) of the first coil is temporarily stored in a strip store during a welding process, and finally, the in-process stock consisting of two lengths is reversibly rolled to a final dimension, and an additional length is welded to the end of the in-process stock before the last pass.

The invention also relates to an installation for effecting the method and in which the unwinding reel (1, 6) is used as a strip store for the reverse pass.

The invention relates to a method of and an installation for rolling a strip-shaped in-process stock in particular a metal strip, and including at least one reversing rolling mill, at least one reel arranged in front of and behind thereof for winding up and unwinding of the metal strip, a welding apparatus, and a strip store.

For rolling an in-process stock, in particular a metal strip, different methods and installations are used. Thus, single stands, reversing stands, tandem rolling mills, and continuous rolling trains are available.

In order to effect a reduction of an in-process stock to a final thickness the in-process stock should pass single stands several times. When several rolling mill stands are arranged one after another to form a tandem rolling mill, the in-process stock should pass the tandem rolling mill only once. The reduction of thickness from a base size to a final size determines the number of installed rolling mill stands. Continuous trains represent a further development of the tandem rolling mills. With this, the strip end of the in-process stock of one coil is connected with a strip beginning of a next coil, e.g., by welding. The advantage of such installation or such a method consists in that the need of insertion of the in-process stock from each coil is eliminated, and the in-process stock is continuously available for the rolling mill train.

However, such an installation can be economically operated only at a large throughput.

With a small amount of all in-process stock, installations with a small number of rolling mill stands are contemplated. Here, a method and an installation are provided, with which the in-process stock passes one or two rolling mill stands several times, without the in-process stock leaving the roll gap. With this, the in-process stock, which is to be wound up to form a coil, is fed from an unwinding reel through one or several rolling mill stands and is wound up on a further reel. In order to effect rolling in several passes, the stock is reciprocated between adjustable rolls.

German Publication DE 43 10 063 A1 discloses an installation for cold rolling of a strip-shaped stock in a single reversing rolling mill stand which is arranged between two reversible reels and includes a reel from which an in-process strip is unwound.

U.S. Pat. No. 2,105,736 discloses a reversing installation with which a stock with a continuous length is rolled off. Here, the installation includes a horizontal strip store arranged, respectively, in front of and behind the rolling mill stand. The in-process stock is fed from a reel to a front strip store. The beginning of the next coil is welded to the strip end of the first coil and is deformed in a rolling mill stand by a reversing process.

However, such installations can be economically operated only at a large throughput.

Accordingly, an object of the invention is a method and an installation that permit an economical treatment of the in-process stock with at least one reversing rolling mill.

This object is achieved according to the invention with a method with which the metal strip is wound up on the unwinding reel during the reverse passes, and a strip beginning of a further metal strip is welded to the strip end of the metal strip before the last pass.

In the inventive installation, the unwinding reel is used as a strip store for the reverse passes.

The embodiments of the invention are recited in the dependent claims.

By welding together two coil lengths, shorter following periods are achieved. In addition, the quantity of waste lengths is reduced because the strip ends are rolled off, and the strip beginning of each further coil is rolled off at least once. Also with the method and installation according to the present invention, the strip beginning and the strip end are always rolled off under optimal tension conditions.

According to an advantageous embodiment of the installation according to the present invention, one of the unwinding reels is simultaneously used as a winding-up reel for a pickling line located upstream. Thereby a costly transportation of separate coils is prevented, and a danger of coils being damaged during the transportation is eliminated.

The present invention further contemplates integration of the pickling line into the installation, e.g., between the welding apparatus and the reversing rolling mill. With this, an adapted, larger strip store is provided.

An embodiment of the invention will be described in detail below based on a very schematic drawing. It is shown in:

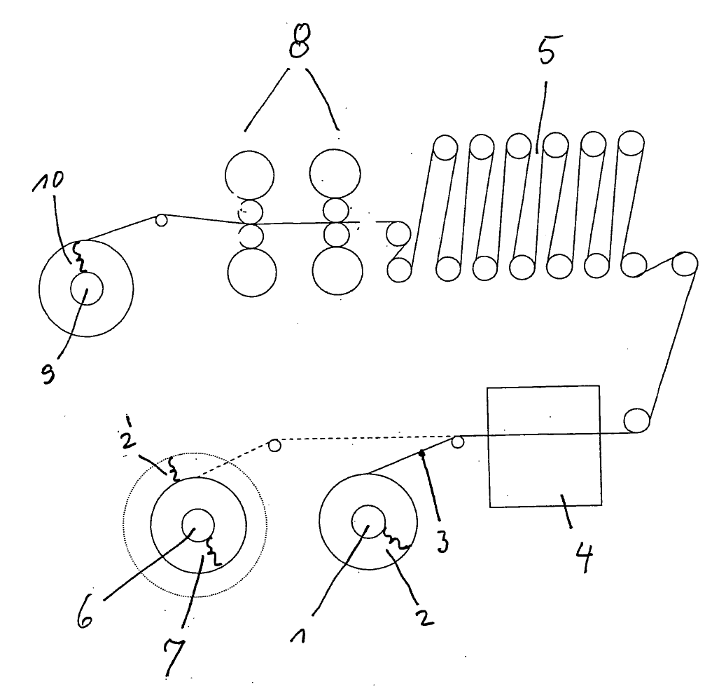

FIG. 1 a two-stand reversing rolling mill according to the invention with a welding apparatus, strip store, and winding-up and unwinding reels.

A single FIGURE shows a reversing rolling mill. A metal strip 3 is unwound from a coil 2 held on an unwinding reel 1 and is fed through a welding apparatus 4, a strip store 5, and a rolling mill stand 8, to a winding-up reel 9 for a first rolling of the coil. Another coil 7 is pre-positioned on a further unwinding reel 6.

At a last one-third of the coil 2, the strip store 5 is actuated in order to bridge the time span to weld the end of the strip form coil 2 with the beginning of the strip from coil 7 for further rolling. Thereby, the metal strip 3 can be rolled off up to the welding seam and several meters beyond that. Upon reversing, for rolling the metal strip 3 to a set thickness by subsequent rolling, the joint metal strip 3 is alternatively wound up on the reel 6 and the reel 9. On the unwinding reel 1, a following coil is already positioned in order to be welded to an end of the metal strip 3 from coil 7.

After the set thickness has been reached, the metal strip 3 is wound up on the winding-up reel 9 to from a coil 10 having a predetermined length. With this, the metal strip 3 is cut off. After the finished coil 3 is taken off from the winding-up reel 9, the remaining metal strip 3 is connected with the winding-up reel 9. Simultaneously, in the welding apparatus 4, a further metal strip 3 from the coil 2 or the coil 7 on the unwinding reel 1 or 6 is welded with the non-deformed metal strip 3 that remains in the strip store 5. Finally, a further deformation of the following length of the metal strip 3 follows without interruption.

The same installation permits to form and roll, to feed and to unwind so-called jumbo-coils (with two or more normal coils forming one coil) in order to cut in half the time-consuming direction reversal of a reversing rolling mil installation. This is based on a premise that the metal strips of the coil have the same dimensions.

1. A method of rolling a strip-shaped in-process stock, in particular a metal strip, with which, a metal strip (3) is unwound from a coil (2, 7) held on an unwinding reel (1, 6), is fed into a reversing rolling mill (8), is rolled, and is wound-up onto a winding-up reel (9) to form a coil (10), wherein the metal strip (3) is reversibly conveyed from the unwinding reel (1, 6) to the winding-up reel (9) until a set thickness is reached and, with each passing of the reversing rolling mill (8), is subjected to a reduction of thickness, and wherein an end of the metal strip (3) of a first coil is welded to a beginning of the metal strip (3) of the second coil, and the metal strip (3) of the first coil is temporarily stored in a strip store during a welding process,
characterized in that the metal strip (3) is wound up onto the unwinding reel (1, 6) during a reversing pass, and a strip beginning of a further strip (3) is welded to the strip end of the metal strip (3) before a last pass.

2. An installation for rolling a strip-shaped in-process stock, in particular a metal strip (3), comprising at least one reversing rolling mill (8) and at least one reel arranged in front of and behind thereof for winding up and unwinding of the metal strip (3), a welding apparatus (4), and a strip store (5),
characterized in that the unwinding reel (1, 6) is used as a strip store for the reverse pass.

3. An installation according to claim 2,
characterized in that the unwinding reel (1, 6) is simultaneously used as a winding up reel for a pickling line located upstream.

4. An installation according to claim 2,
characterized in that
the winding-up reel (9) after the reversing rolling mill (8) is formed as a single reel or as a carousel reel.

5. An installation according to one of claims claim 2,
characterized in that a pickling line is integrated between the welding apparatus (4) and the strip store (5).
